(19) United States
(12) Patent Application Publication
(10) Pub. No.: US 2025/0171949 A1
(43) Pub. Date: May 29, 2025

(54) CLOTHING DRYER HAVING LINT REMOVING DEVICE

(71) Applicant: SAMSUNG ELECTRONICS CO., LTD., Suwon-si (KR)

(72) Inventor: Shigenori HATO, Kanagawa (JP)

(73) Assignee: SAMSUNG ELECTRONICS CO., LTD., Suwon-si (KR)

(21) Appl. No.: 19/039,353

(22) Filed: Jan. 28, 2025

Related U.S. Application Data
(63) Continuation of application No. PCT/KR2023/006633, filed on May 16, 2023.

(30) Foreign Application Priority Data
Sep. 22, 2022 (JP) 2022-151489

(51) Int. Cl. D06F 58/22

(52) U.S. Cl. CPC D06F 58/22

(57) ABSTRACT

A clothing dryer includes: a blowing path through which warm air circulates; a heat exchanger in the blowing path and configured to supply heat to the warm air; and a lint filter unit at an upstream side of the heat exchanger in the blowing path and configured to filter lint from the warm air. The lint filter unit includes: a unit body including an intermediate path connected to the blowing path and an opening, located at the upstream side of the heat exchanger in the blowing path; a lint filter in the intermediate path and configured to filter the lint in the warm air; a filter cleaner movable relative to the lint filter and configured to scrape off the lint attached to the lint filter; and a lid configured to open and close the opening, and block and allow movement of the lid in a closing and opening position.

### CROSS-REFERENCE TO RELATED APPLICATIONS

This application is a continuation of International Application No. PCT/KR2023/006633, filed on May 16, 2023, which is based on and claims priority to Japanese Patent Application No. 2022-151489, filed on Sep. 22, 2022, in the Korean Intellectual Property Office, the disclosures of which are incorporated by reference herein in their entireties.

### BACKGROUND

### 1. Field

The present disclosure relates to a dryer having a lint removing device. The dryer may be a home laundry dryer or a clothing dryer.

### 2. Description of the Related Art

In a laundry dryer or clothing dryer (hereinafter simply referred to as a dryer), which dries clothing by circulating and supplying warm air, lint generated during a drying process of clothing may enter a blowing path along with the warm air. In order to prevent lint from entering a heat exchanger, a filter that filters out lint, a so-called lint removal device, is installed in the blowing path.

The lint filter may be a two-stage filter including a main filter and an auxiliary filter on a downstream side thereof. Lint is mostly filtered out by the main filter, and the auxiliary filter filters out a small amount of fine lint that passes through the main filter. The auxiliary filter prevents lint from leaking downstream of the blowing path even when the main filter is damaged.

When the amount of lint captured by the lint filter increases, a mesh of the filter becomes clogged, which makes it difficult for the warm air to pass through the lint filter. Therefore, in order to dry clothing efficiently, it is necessary to regularly remove lint from the lint filter so that the mesh of the lint filter does not become clogged.

When a flow rate of the warm air decreases, a user needs to detach the lint filter from a dryer, remove the lint stuck on the lint filter with a brush, etc., and then reattach the lint filter to the dryer. Such work of cleaning the lint filter may be complicated and burdensome to the user. When the lint filter is a two-stage structure, the burden of the cleaning work is doubled. Therefore, it is necessary to simplify the work of cleaning the lint filter.

For example, Japanese Publication No. 7-694 discloses a lint removal device that accommodates a filter cleaning tool of a small diameter inside a cylindrical filter that may be withdrawn from a duct. One inner end of the filter cleaning tool is fixed to a duct. An annular brush portion contacting an inner surface of the filter is installed at another inner end of the filter cleaning tool. As the filter is taken, the brush portion may move along the inner surface of the filter, and lint attached to the inner surface of the filter may be scraped off.

Japanese Publication No. 2019-30506 discloses a lint removal device of a two-stage structure including a backup filter portion and a filter member. The filter member corresponding to a main filter is mounted in an arc shape on a filter unit. The backup filter portion corresponding to an auxiliary filter is mounted in a duct accommodating the filter unit. An operation mechanism for opening and closing a filter cover, and a cleaning mechanism for scraping off lint from the filter by rotating the cleaning member unit accompanied by the operation of the operation mechanism are installed on the filter unit.

### SUMMARY

According to an aspect of the present disclosure, a clothing dryer includes: a blowing path through which warm air circulates; a heat exchanger in the blowing path and configured to supply heat to the warm air; and a lint filter unit at an upstream side of the heat exchanger in the blowing path and configured to filter lint from the warm air. The lint filter unit includes: a unit body including an intermediate path connected to the blowing path and an opening, located at the upstream side of the heat exchanger in the blowing path, for a part of the intermediate path; a lint filter in the intermediate path and configured to filter the lint included in the warm air; a filter cleaner movable relative to the lint filter and configured to scrape off the lint attached to the lint filter; and a lid configured to open and close the opening, block movement of the filter cleaner in a state in which the lid is at a closing position, and allow movement of the filter cleaner in a state in which the lid is at an opening position.

The unit body may further include a warm air inlet through which the warm air flows from the intermediate path, and a warm air outlet through which the warm air is discharged from the intermediate path. The lint filter may be located at the warm air outlet.

A cross-sectional area of the warm air outlet may be greater than a cross-sectional area of the warm air inlet.

The lint filter may include: a main filter; and an auxiliary filter at downstream side of the main filter. The filter cleaner may include: a first cleaning member that may be configured to clean the main filter; and a second cleaning member that may be configured to clean the auxiliary filter.

In a state in which the lid is at the closing position, the first cleaning member may be locked in a standby position by the lid.

In a state in which the first cleaning member is no longer in the standby position, the first cleaning member may interfere with the lid. In a state in which the first cleaning member interferes with the lid, the lid may not be switched to the closing position.

In a state in which the lid is at the opening position, the first cleaning member may be movable from the standby position in a longitudinal direction of the intermediate path and may be configured to scrape off the lint attached to the main filter, and the second cleaning member may be movable in the longitudinal direction of the intermediate path together with the main filter and may be configured to scrape off the lint attached to the auxiliary filter.

In a state in which the lid is at the opening position, the second cleaning member may be movable along an arc-shaped path in a width direction of the intermediate path together with the main filter, and the first cleaning member may be configured to scrape off the lint from the main filter that is moved relative to a fixed position.

The unit body may further include: an outer cylinder including an outer end opening in a longitudinal direction, an outer edge opening in a width direction, and an outer ventilation window; and an inner cylinder including an inner end opening in the longitudinal direction, an inner edge opening in the width direction, and an inner ventilation window, the inner cylinder may be insertable into the outer cylinder through the outer end opening and the intermediate path may be inside the inner cylinder. The outer end opening and the inner end opening may form the warm air inlet in the intermediate path. The outer edge opening and the inner edge opening may form the opening. The outer ventilation window and the inner ventilation window may form the warm air outlet facing the heat exchanger and through which the warm air is discharged from the intermediate path. The lint filter may further include a main filter in the inner ventilation window and an auxiliary filter in the outer ventilation window.

The filter cleaner may further include: a first cleaning member including a first scraper on the inner cylinder and contacting the main filter, and movable in the longitudinal direction of the intermediate path; and a second cleaning member on the inner cylinder and may be configured to scrape off the lint attached to the auxiliary filter in a state in which the inner cylinder is removed from the outer cylinder.

The lid may further include a regulation rib. In a state in which the inner cylinder is inserted into the outer cylinder to an inserted position, the first cleaning member may be at a standby position, and the lid may be at the closing position, the regulation rib may be configured to lock the first cleaning member in the standby position.

In a state in which the lid is at the closing position, the inner cylinder may be blocked from moving to the outer cylinder by the regulation rib.

In a state in which the first cleaning member is at a position other than the standby position, and the inner cylinder may not be inserted into the outer cylinder to the inserted position, the regulation rib may be configured to contact the first cleaning member when the lid is switched to the closing position. The lid may be prevented from being at the closing position by the regulation rib.

The lint filter may further include: a main filter; and an auxiliary filter at a downstream side of the main filter. The unit body may further include: a base which may have a cylindrical shape in a fan-shaped cross-sectional area, the auxiliary filter may be on an arc-shaped outer circumferential surface, and the opening may be in one surface facing the arc-shaped outer circumferential surface; and a cover which may have an arc-shaped cross-section detachably inside the base through the opening, the main filter facing the auxiliary filter. The filter cleaner may further include: a first cleaning member supported by the base and contacting the main filter; and a second cleaning member supported by the cover and contacting the auxiliary filter. The filter cleaner may be configured to simultaneously scrape off the lint attached to the main filter and the auxiliary filter, via the first cleaning member and the second cleaning member, by taking the cover out of the base in a state in which the lid is at the opening position.

The opening of the unit body may be in a lower surface of the unit body.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic block diagram of a clothing dryer according to one or more embodiments of the disclosure;

FIG. 2 is a schematic perspective view of a lint filter unit according to one or more embodiments of the disclosure;

FIG. 3 is a schematic perspective view showing an inverted state of a lint filter unit according to one or more embodiments of the disclosure;

FIG. 4 is a schematic exploded view of a lint filter unit according to one or more embodiments of the disclosure;

FIG. 5 is a schematic cross-sectional perspective view taken along line Y1-Y1 of FIG. 3;

FIG. 6 is a schematic cross-sectional view taken along line Y2-Y2 of FIG. 3;

FIG. 7 is a schematic perspective view of a first cleaning mechanism according to one or more embodiments of the disclosure;

FIG. 8 is a schematic perspective view of a lint filter unit according to one or more embodiments of the disclosure;

FIG. 9 is a schematic exploded perspective view of the lint filter unit according to one or more embodiments of the disclosure shown in FIG. 8;

FIG. 10 is a schematic cross-sectional perspective view taken along line Y3-Y3 of FIG. 8;

FIG. 11 is a schematic cross-sectional view taken along the line Y3-Y3 of FIG. 8;

### DETAILED DESCRIPTION

It should be appreciated that various embodiments of the disclosure and the terms used therein are not intended to limit the technological features set forth herein to particular embodiments of the disclosure, and include various changes, equivalents, or alternatives for a corresponding embodiment.

With reference to descriptions of drawings, similar reference numerals may be used to refer to similar or related elements.

It is to be understood that a singular form of a noun corresponding to an item may include the item or a plurality of the items, unless the context clearly indicates otherwise.

As used herein, expressions such as “A or B”, “at least one of A and B”, “at least one of A or B”, “A, B or C”, “at least one of A, B, and C”, “at least one of A, B, or C” may include any one of, or all available combinations of the items enumerated together in a corresponding one of the phrases.

As used herein, the term “and/or” includes any one or a combination of a plurality of related recited elements.

Terms such as “1^{st}” and “2^{nd}” or “first” and “second” may be used to simply distinguish a corresponding element from another, and does not limit the elements in other aspect (e.g., importance or order).

When an element (e.g., a first element) is referred to, with or without the term “operatively” or “communicatively”, as being “coupled with,” “coupled to,” “connected with,” or “connected to” another element (e.g., a second element), it means that the element may be connected to the other element directly (e.g., in a wired manner), wirelessly, or via a third element.

As used here, such terms as “comprises,” “includes,” or “has” specify the presence of stated features, numbers, stages, operations, elements, parts, or a combination thereof, but do not preclude the presence or addition of one or more other features, numbers, stages, operations, elements, parts, or a combination thereof.

When an element is referred to as being “connected to,” “coupled to,” “supported by,” or “in contact with” another element, it means that the element is directly connected to, coupled to, supported by, or in contact with the other element, or that the element is indirectly connected to, coupled to, supported by, or in contact with the other element via a third element.

When an element is referred to as being “on” another element, it means that the element is in contact with the other element, or that still another element is present between the element and the other element.

A washing machine according to various embodiments of the disclosure may perform washing, rinse, spin, and drying cycles. A washing machine is an example of a laundry treatment device, and the laundry treatment device is a concept collectively including a device for washing clothing (a target object to be washed and a target object to be dried), a device for drying clothing, and a device capable of performing both washing and drying of clothing.

A washing machine according to various embodiments of the disclosure may include a top-loading washing machine in which an inlet for putting in or taking out laundry is provided at the top, or a front-loading washing machine in which an inlet for putting in or taking out laundry is provided at the front. The washing machine according to various embodiments of the disclosure may include a washing machine of a loading type other than the top-loading washing machine and the front loading washing machine.

The top-loading washing machine may wash laundry by using a water current generated by a rotating body such as a pulsator. The front-loading washing machine may wash laundry by rotating a drum to repeatedly raise and drop the laundry. The front-loading washing machine may include a washing and drying-combination machine capable of drying laundry in a drum thereof. The washing and drying-combination machine may include a hot air supply device for supplying high-temperature air to the inside of the drum and a condensing device for removing moisture in an air discharged from the drum. For example, the washing and drying-combination machine may include a heat pump device. The washing machine according to various embodiments of the disclosure may include washing machines with washing schemes different from washing schemes described above.

The washing machine according to various embodiments of the disclosure may include a housing for internally accommodating various elements. The housing may be provided in a box shape having a laundry inlet that is formed at one side.

The washing machine may include a door for opening and closing the laundry inlet. The door may be rotatably mounted on the housing by a hinge. At least a portion of the door may be transparent or translucent such that the interior of the housing is visible.

The washing machine may include a tub provided in the housing so as to store water. The tub may be provided having a substantially cylindrical shape with a tub opening at one side, and may be disposed in the housing so as to allow the tub opening to correspond to the laundry inlet.

The tub may be connected to the housing by a damper. The damper may absorb a vibration occurring in rotation of the drum, and thus, may dampen the vibration transferred to the housing.

The washing machine may include a drum provided to accommodate laundry.

The drum may be provided in the tub so as to allow a drum opening at one side of the drum to correspond to the laundry inlet and the tub opening. Laundry may sequentially pass through the laundry inlet, the tub opening, and the drum opening so as to be accommodated in the drum or may be taken out of the drum.

The drum rotates in the tub, thereby performing each operation according to washing, rinse, and/or spin cycles. The drum may include a plurality of through holes in its cylindrical wall, such that water stored in the tub may flow into the drum or may be discharged out of the drum.

The washing machine may include a driving device configured to rotate the drum. The driving device may include a driving motor, and a rotation axis for transmitting a driving force generated by the driving motor to the drum. The rotation axis may be connected to the drum via the tub.

The driving device may perform each operation according to washing, rinse, and/or spin cycles, or a drying cycle by rotating the drum forward or backward.

The washing machine may include a water supply device configured to supply water into the tub. The water supply device may include a water supply pipe, and a water supply valve provided at the water supply pipe. The water supply pipe may be connected to an external water supply source. The water supply pipe may be extended from the external water supply source to a detergent supply device and/or the tub. Water may be supplied into the tub via the detergent supply device. Water may be supplied into the tub without going via the detergent supply device.

The water supply valve may open or close the water supply pipe, in response to an electric signal of a controller. The water supply valve may allow or block the supply of water from the external water supply source to the tub. For example, the water supply valve may include a solenoid valve being open or close, in response to an electric signal.

The washing machine may include the detergent supply device configured to supply a detergent to the tub. The detergent supply device may include a manual-type detergent supply device that requires a user to input a detergent to be used in every washing, and an automatic-type detergent supply device that stores a large amount of detergents and automatically inputs a preset amount of detergent in washing. The detergent supply device may include a detergent box to store a detergent. The detergent supply device may be configured to supply a detergent into the tub in a water supply process. Water supplied via the water supply pipe may be mixed with a detergent via the detergent supply device. The water mixed with the detergent may be supplied into the tub. The term ‘detergent’ is used to collectively refer to a detergent for pre-washing, a detergent for main-washing, a fabric softer, a bleaching agent, etc., and the detergent box may be partitioned into a storage area of a detergent for pre-washing, a storage area of a detergent for main-washing, a storage area of a fabric softer, and a storage area of a bleaching agent.

The washing machine may include a drain device configured to externally discharge water from the tub. The drain device may include a drain pipe extending from the bottom of the tub to the outside of the housing, a drain valve provided at the drain pipe so as to open/close the drain pipe, and a pump provided on the drain pipe. The pump may pump water of the drain pipe to the outside of the housing.

The washing machine may include a control panel provided at one side of the housing. The control panel may provide a user interface for interaction between a user and the washing machine. The user interface may include at least one input interface and at least one output interface.

The at least one input interface may convert sensory information received from the user into an electric signal.

The at least one input interface may include a power button, an operation button, a course selection dial (or a course selection button), and a washing/rinse/spin setting button. The at least one input interface may include a tact switch, a push switch, a slide switch, a toggle switch, a micro-switch, a touch switch, a touch pad, a touch screen, a jog dial, and/or a microphone.

The at least one output interface may visually or acoustically transmit information related to an operation of the washing machine to a user.

For example, the at least one output interface may transmit, to the user, information related to a washing course and operation time of the washing machine, and information related to a washing setting/rinse setting/spin setting. The information about the operation of the washing machine may be output through a screen, an indicator, or sound, etc. The at least one output interface may include a liquid-crystal display (LCD) panel, a light-emitting diode (LED) panel, a speaker, etc.

The washing machine may include a communication module for wired and/or wireless communication with an external device.

The communication module may include at least one of a short-range communication module or a long-range communication module.

The communication module may transmit data to an external device (e.g., a server, a user device and/or home appliance) or may receive data from the external device. For example, the communication module may establish communication with a server and/or a user device and/or home appliance, and may transmit and receive various data.

To this end, the communication module may support establishment of a direct (e.g., wired) communication channel or a wireless communication channel with the external device, and communication via the established communication channel. According to one or more embodiments of the disclosure, the communication module may include a wireless communication module (e.g., a cellular communication module, a short-range wireless communication module, or a global navigation satellite system (GNSS) communication module) or a wired communication module (e.g., a LAN communication module, or a power line communication module). A corresponding communication module from among communication modules may communicate with the external device via a first network (a short-range communication network such as Bluetooth, wireless fidelity (WiFi) direct, or infrared data association (IrDA)) or a second network (a long-range communication network such as a legacy cellular network, a 5^{th} generation (5G) network, a next-generation communication network, the Internet, or a computer network (e.g., a LAN or a wide area network (WAN)). The various types of communication modules may be integrated as one element (e.g., a single chip) or implemented as a plurality of separate elements (e.g., a plurality of chips).

A short-range wireless communication module may include, but is not limited to, a Bluetooth communication module, a Bluetooth Low Energy (BLE) communication module, a near field communication (NFC) module, a WLAN (Wi-Fi) communication module, a ZigBee communication module, an IrDA communication module, a WiFi direct (WFD) communication module, an ultra wideband (UWB) communication module, an Ant+ communication module, a microwave (uWave) communication module etc.

A long-range communication module may include communication modules for performing various types of long-range communication, and may include a mobile communication unit. The mobile communication unit transmits and receives a wireless signal to and from at least one of a base station, an external terminal, or a server, on a mobile communication network.

According to one or more embodiments of the disclosure, the communication module may communicate with the external device including a server, a user device, other home appliances, etc. via a neighboring access point (AP). The AP may connect a LAN to which the washing machine or the user device is connected to a WAN to which the server is connected. The washing machine or the user device may be connected to the server via the WAN. A control unit may control various elements (e.g., the driving motor, the water supply valve, etc.) of the washing machine. The control unit may control various elements of the washing machine to perform at least one cycle including water supply, washing, rinse, and/or spin, in response to a user input. For example, the control unit may control the driving motor to adjust a rotation speed of the drum or may control the water supply valve of the water supply device to supply water to the tub.

The control unit may include hardware such as a central processing unit (CPU), a memory, etc., and software such as a control program, etc. For example, the control unit may include at least one memory storing data in forms of algorithm and a program to control operations of elements in the washing machine, and at least one processor to perform the aforementioned operation by using the data stored in the at least one memory. The memory and the processor may each be implemented as a separate chip. The processor may include one processor chip or two or more processor chips, or may include one processing core or two or more processing cores. The memory may include one memory chip or two or more memory chips or may include one memory block or two or more memory blocks. Also, the memory and the processor may be implemented as one chip.

Because a filter cleaning tool disclosed in Japanese Publication No. 7-694 is fixed to a duct, it may be difficult for a lint removing device to remove lint attached to a brush. A lint removing device disclosed in Japanese Publication No. 2019-30506 has no such disadvantage because a cleaning mechanism is integrated into a filter unit. However, the lint removing device disclosed in Japanese Publication No. 2019-30506 has a complex structure, high component cost, and may cause an operation failure due to lint caught between a cleaning member and the filter unit. In addition, the lint removing device disclosed in Japanese Publication No. 7-694 has no auxiliary filter. On the other hand, the lint removing device disclosed in Japanese Publication No. 2019-30506 has a backup filter unit. However, it may be difficult to clean the backup filter unit because the backup filter unit is assembled in the duct.

The present disclosure relates to a lint removing device disposed in a blowing path that circulates and supplies warm air to dry clothing, and a clothing dryer employing the lint removing device. The present disclosure provides a lint removing device that may easily clean both a main filter and an auxiliary filter while having a relatively simple structure, and a clothing dryer employing the lint removing device. The clothing dryer may be a clothing dryer having a drying function, or a clothing dryer having a washing function and a drying function. The clothing dryer having the washing function and the drying function is also referred to as a laundry dryer. Hereinafter, one or more embodiments of a lint removing device and a clothing dryer according to the disclosure will be described. In the following description, front, rear, left, right, top, and bottom directions are indicated by arrows in each drawing.

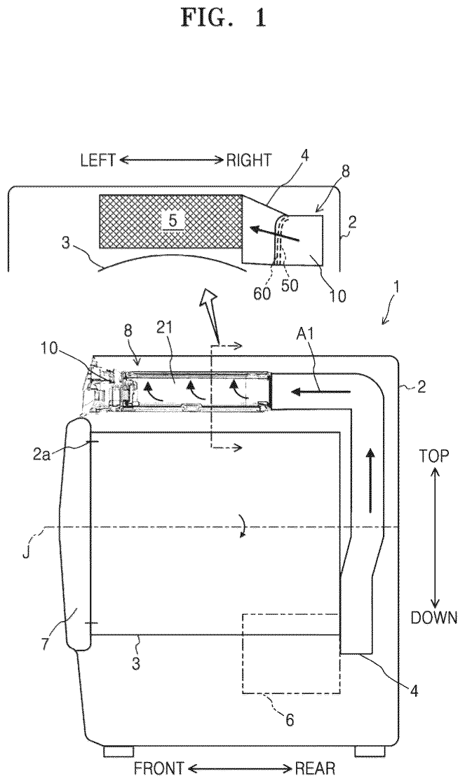

FIG. 1 is a schematic block diagram of a clothing dryer 1 according to one or more embodiments of the disclosure. FIG. 1 is the schematic cross-sectional view of the clothing dryer 1 viewed from the right. A schematic cross-sectional view of an upper region of the clothing dryer 1 viewed from the front is also shown in an upper part of FIG. 1. Referring to FIG. 1, the clothing dryer 1 may include a blowing path 4 in which warm air to be supplied to clothing to be dried is circulated, a heat exchanger 5 installed in the blowing path 4 to supply heat to the warm air, and a lint filter unit 10 located at an upstream side of the heat exchanger 5 in the blowing path 4 to remove or filter lint from the warm air.

The clothing dryer 1 includes a housing 2. For example, the housing 2 may have a substantially rectangular parallelepiped box shape. A drum 3, the blowing path 4, the heat exchanger 5, a blowing device 6, etc. are installed in the housing 2. A circular inlet 2a is provided in a front surface of the housing 2. The door 7 opens and closes the inlet 2a. The cylindrical drum 3 with a bottom is installed inside the housing 2. The drum 3 is disposed so that the bottom faces the rear and an opening faces the inlet 2a in the front.

The clothing to be washed and/or dried is put into the drum 3 through the inlet 2a. The drum 3 is accommodated in the housing 2 so as to be rotated around a rotation axis J extending in front and rear directions. The drum 3 is rotated and driven by a driving mechanism which is not shown.

The blowing path 4 is provided in the housing 2. The warm air circulates along the blowing path 4 and is supplied to the inside of the drum 3 via the heat exchanger 5. The blowing device 6 is installed in the blowing path 4, and air flows as indicated by arrow A1 along the blowing path 4 by an operation of the blowing device 6.

For example, the heat exchanger 5 may be located in an upper region of the housing 2. The heat exchanger 5 forms a heat pump unit together with a compressor, an evaporator, etc., which are not shown. For example, the heat exchanger 5 may be located above the drum 3. The heat exchanger 5 may be disposed in the central portion of the upper region of the housing 2 in left and right directions.

The air flowing along the blowing path 4 is heated and dried by passing through the heat exchanger 5 to become warm air. The warm air is supplied to the drum 3. Air exhausted from the drum 3 flows back into the blowing path 4 so that warm air circulates in and is supplied to the drum 3.

The warm air discharged from the drum 3 is mixed with lint removed from the clothing. In order to prevent lint from entering the heat exchanger 5, a lint removing device may be installed at the upstream side of the heat exchanger 5 in the blowing path 4.

The clothing dryer 1 includes a lint filter accommodation chamber 8. The lint filter accommodation chamber 8 is located at the upstream side of the heat exchanger 5 in the blowing path 4. For example, the lint filter accommodation chamber 8 may have a substantially rectangular cross-section, have a cylindrical shape extending in the front and rear directions, and be, for example, disposed in the upper region of the housing 2. In the upper region, the lint filter accommodation chamber 8 may be located adjacent to a right side of the heat exchanger 5.

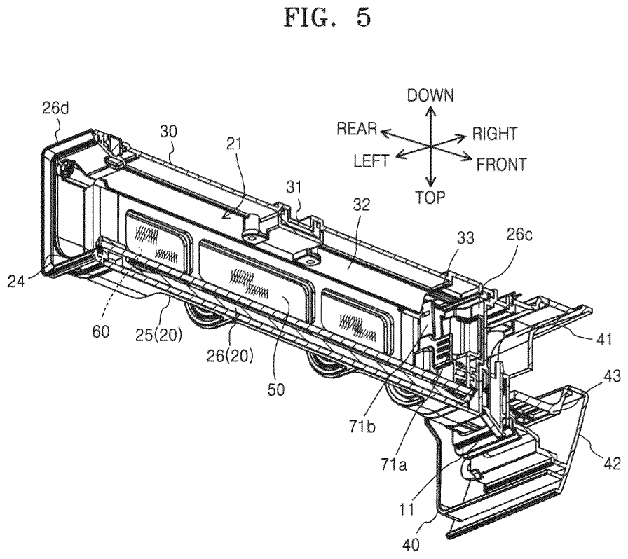

The lint removing device includes a lint filter unit 10. The lint filter unit 10 is located at the upstream side of the heat exchanger 5 in the blowing path 4 to filter off the lint from the warm air. The lint filter unit 10 may be detachably accommodated in the lint filter accommodation chamber 8. As will be described below, the lint filter unit 10 may slide in a longitudinal direction of an intermediate path (21: FIG. 5) to be mounted/detached into/from the lint filter accommodation chamber 8. The longitudinal direction of the intermediate path (21: FIG. 5) may be the front and rear directions in FIG. 1. A width direction of the intermediate path (21: FIG. 5) may be the left and right directions and up and down directions in FIG. 1.

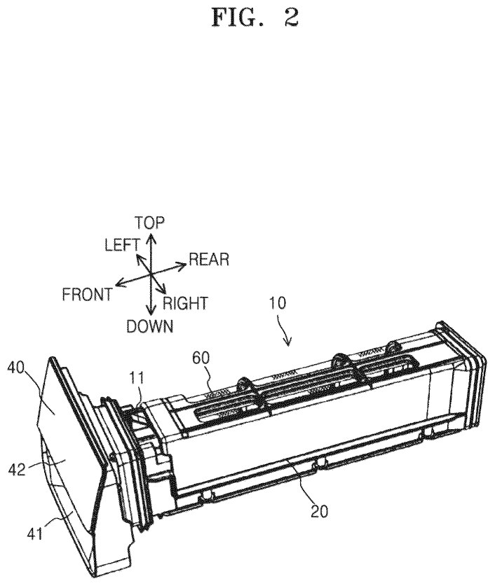

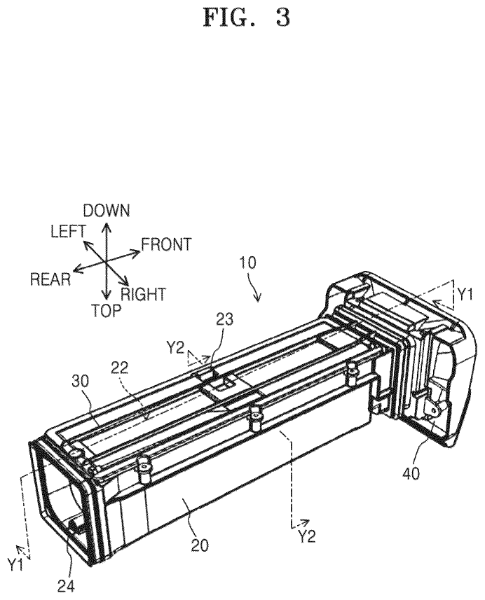

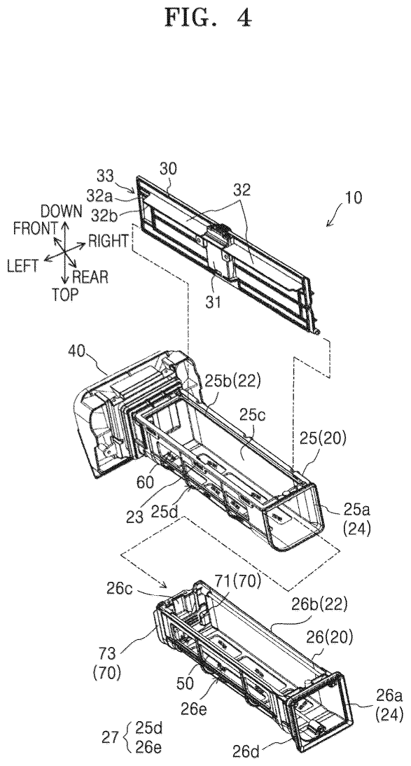

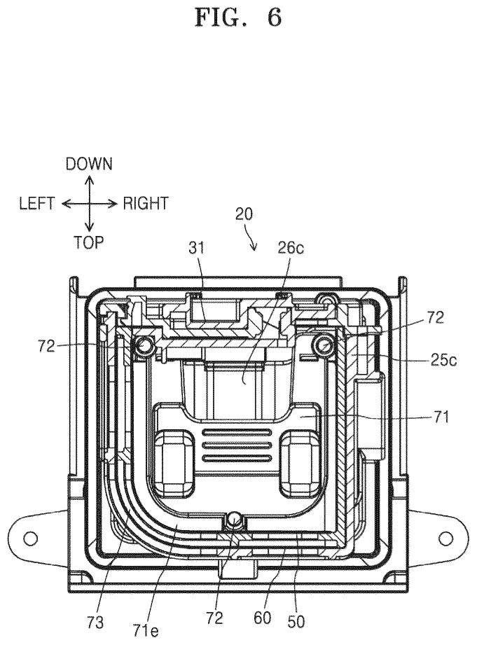

FIG. 2 is a schematic perspective view of the lint filter unit 10 according to one or more embodiments of the disclosure. FIG. 3 is a schematic perspective view showing an inverted state of the lint filter unit 10 according to one or more embodiments of the disclosure. FIG. 4 is a schematic exploded view of the lint filter unit 10 according to one or more embodiments of the disclosure. FIG. 5 is a schematic cross-sectional perspective view taken along line Y1-Y1 of FIG. 3. FIG. 6 is a schematic cross-sectional view taken along line Y2-Y2 of FIG. 3. Referring to FIGS. 2 to 6, the lint filter unit 10 may include a unit body 20, a lint filter, a filter cleaning mechanism 70, and a lid 30.

The unit body 20 has a shape that may be accommodated in the lint filter accommodation chamber 8. For example, the unit body 20 may have a cylindrical shape with a substantially rectangular cross-section. The unit body 20 may include an intermediate path 21 connected to the blowing path 4, and an opening 22 that opens a part of the intermediate path 21. The intermediate path 21 may be defined by an inner space of the unit body 20. The intermediate path 21 forms a part of the blowing path 4. The opening 22 may be provided on a lower surface of the unit body 20. The opening 22 may be formed almost over the entire lower surface of the unit body 20.

The lint filter is disposed in the intermediate path 21 to filter off lint included in warm air. The lint filter may include a main filter 50 and an auxiliary filter 60. The auxiliary filter 60 is disposed at a downstream side of the main filter 50 with respect to a flow direction of the warm air. The filter cleaning mechanism 70 is movable relative to the lint filter, for example, the main filter 50 and the auxiliary filter 60, to scrape off lint attached to the main filter 50 and the auxiliary filter 60. The filter cleaning mechanism 70 is slidable in a longitudinal direction of the intermediate path 21 while in contact with the lint filter, for example, the main filter 50 and the auxiliary filter 60.

The lid 30 opens and closes the opening 22. The lid 30 may be supported to be openable and closable by the unit body 20. For example, as shown in FIG. 4, the lid 30 may be rotatably supported on a right edge of the opening 22, and rotated with respect to the unit body 20 to be switched to an opening position that opens the opening 22 and a closing position that closes the opening 22. An engaging portion 23 may be provided at one edge, for example, a left edge, of the opening 22. The engaging portion 23 may be provided at the center of the left edge of the opening 22 with respect to, for example, front and rear directions. A latch 31 engaged by the engaging portion 23 may be provided at an edge of the lid 30, for example, a right edge of the lid 30, facing the engaging portion 23. A user may operate the latch 31, so that the lid 30 may be switched to the opening position and the closing position. The latch 31 is engaged with the stopper 23, so that the lid 30 may be locked in the closing position covering the opening 22. The latch 31 may be released from the engaging portion 23 and the lid 30 may be switched from the closing position to the opening position opening the opening 22.

The lint filter unit 10 may further include a handle 40. For example, the handle 40 may be coupled to a front end of the unit body 20. A front surface of the handle 40 may be formed corresponding to the shape of a front surface of the housing 2. For example, the handle 40 may be a resin molded product. The lint filter unit 10 may be mounted on the housing 2 by accommodating the unit body 20 in the lint filter accommodation chamber 8 with the handle 40 facing forward so as to be exposed to the front of the housing 2.

Referring to FIGS. 2 and 5, a clamp protrusion 11 engaged with an engaging portion (not shown) of the housing 2 is provided in the handle 40. For example, the clamp protrusion 11 may be provided on an upper portion of the handle 40. The clamp protrusion 11 is elastically biased upward by a spring which is not shown. The clamp protrusion 11 is engaged with the engaging portion of the housing 2 by an elastic force of the spring while the lint filter unit 10 is inserted into the lint filter accommodation chamber 8. A lever 43 capable of operating the clamp protrusion 11 is provided in the handle 40. The clamp protrusion 11 may be released from the engaging portion of the housing 2 by operating the lever 43, and the lint filter unit 10 may be pulled in the longitudinal direction, for example, forward, of the intermediate path 21 and taken out of the lint filter accommodation chamber 8.

A warm air inlet 24 is provided in the unit body 20. The warm air flows into the intermediate path 21 through the warm air inlet 24. The warm air inlet 24 may be provided at one end, for example, at the rear end, of the unit body 20 in the longitudinal direction. A warm air outlet 27 through which warm air is discharged from the intermediate path 21 is provided in the unit body 20. The warm air outlet 27 may be provided on a surface of the unit body 20 in a width direction, for example, an outer circumferential surface reaching a left side surface and an upper surface. The main filter 50 and the auxiliary filter 60 are installed in the warm air outlet 27 to contact the intermediate path 21. As will be described below, the auxiliary filter 60 is disposed at a downstream side of the main filter 50 with respect to the flow direction of the warm air. The auxiliary filter 60 is disposed outside the main filter 50 to be adjacent to the main filter 50.

A filter filtering off lint may have a single-stage structure, but a two-stage structure is more preferable. The lint filter employed in the lint filter unit 10 of the disclosure has a two-stage structure including the main filter 50 and the auxiliary filter 60. The lint is mostly filtered off by the main filter 50, and the auxiliary filter 60 filters off a small amount of fine lint passing through the main filter 50.

The main filter 50 and the auxiliary filter 60 may have the same mesh size. The mesh size of the auxiliary filter 60 may be less than the mesh size of the main filter 50. Then, the lint may be dispersed in two stages and filtered out, thereby suppressing the mesh of the auxiliary filter 60 and the main filter 50 from being clogged. The auxiliary filter 60 also exerts a function of not leaking lint downstream even when the filter 50 is damaged.

As shown in FIG. 1, the unit body 20 is disposed to extend from the front to the rear while the outer circumferential surface where the main filter 50 and the auxiliary filter 60 are installed faces the heat exchanger 5. That is, the intermediate path 21 extends in the front and rear directions with the lint filter unit 10 mounted in the lint filter accommodation chamber 8 of the housing 2. The warm air inlet 24 is located in a rear side of the intermediate path 21. The warm air flowing into the intermediate path 21 through the warm air inlet 24 flows from the rear to the front along the intermediate path 21, then changes its direction to a left direction (specifically, to the upper left), passes through the main filter 50 and the auxiliary filter 60, is discharged through the warm air outlet 27, and flows toward the heat exchanger 5.

A cross-sectional area of the warm air outlet 27 may be larger than a cross-sectional area of the warm air inlet 24. In other words, a flow path cross-sectional area orthogonal to a width direction of the intermediate path 21, that is, the left and right directions, may be larger than a flow path cross-sectional area orthogonal to a longitudinal direction, that is, the front and rear directions. Therefore, even when there is a flow resistance by filters (the main filter 50 and the auxiliary filter 60), warm air may smoothly flow into the heat exchanger 5. The warm air inlet 24 is located in a rear region of the housing 2 while the lint filter unit 10 is accommodated in the lint filter accommodation chamber 8. That is, the warm air inlet 24 faces the rear of the housing 2, and thus, the blowing path 4 connecting the blowing device 6 to the lint filter unit 10 is easily disposed inside the housing 2.

The opening 22 and the lid 30 are located at bottom side while the lint filter unit 10 is accommodated in the lint filter accommodation chamber 8. When the lint filter unit 10 is taken from the lint filter accommodation chamber 8, because the opening 22 and the lid 30 face downward, opening and closing operations of the lid 30 need to be properly performed.

Referring to FIGS. 2 and 5, the handle 40 may include an insertion port 41 and a grip portion 42. The insertion port 41 is formed concavely from a front portion of the handle 40 to the rear at the bottom of the front portion. The grip portion 42 is located above the insertion port 41 and partially covers the insertion port 41. The user may grip the handle 40 by inserting a finger into the insertion port 41 and gripping the grip portion 42. The user may grip the handle 40 and slide the lint filter unit 10 in the longitudinal direction of the intermediate path 21 to accommodate/remove the lint filter unit 10 in/from the lint filter accommodation chamber 8. For example, while the lint filter unit 10 is accommodated in the lint filter accommodation chamber 8, the clamp protrusion 11 may be released from the engaging portion of the housing 2 by operating the lever 43 with the finger inserted into in the insertion port 41 and the lint filter unit 10 may be pulled forward and removed from the lint filter accommodation chamber 8.

As one or more embodiments, referring to FIG. 4, the unit body 20 may include an outer cylinder 25 and an inner cylinder 26 insertable into the outer cylinder 25. The inner cylinder 26 is detachable from the outer cylinder 25. The outer cylinder 25 forms an outer portion of the unit body 20. For example, the outer cylinder 25 may have a cylindrical shape having a substantially rectangular cross-section. The handle 40 is coupled to a front end of the outer cylinder 25. An outer end opening 25a in the longitudinal direction, an outer edge opening 25b in the width direction, and an outer ventilation window 25d are provided in the outer cylinder 25.

One end of the outer cylinder 25 is opened as the warm air inlet 24. For example, the outer end opening 25a is provided at a rear end of the outer cylinder 25 in the longitudinal direction and functions as the warm air inlet 24. One surface of the outer cylinder 25 is opened as the opening 22. The outer edge opening 25b is provided in one surface of the outer cylinder 25 in the width direction, for example, an upper surface, and functions as the opening 22. The lid 30 may be rotatably installed, for example, at a right edge of the outer edge opening 25b. One surface of the outer cylinder 25 in the width direction, for example, a right side surface, is covered by a sidewall 25c. A plurality of outer ventilation windows 25d are formed in a grid shape in a surface of the outer cylinder 25 in the width direction, for example, a part from the upper surface to a left side surface. The auxiliary filter 60 is provided in the plurality of outer ventilation windows 25d and covers the plurality of outer ventilation windows 25d. The auxiliary filter 60 may be attached to an inner surface of the outer cylinder 25. For example, the auxiliary filter 60 may include a sheet shape resin mesh.

The inner cylinder 26 has a cylindrical shape with an intermediate path 21 inside thereof, and may be insertable into the outer cylinder 25. A cross-sectional shape of the inner cylinder 26 may be similar to a cross-sectional shape of the outer cylinder 25. The inner cylinder 26 may have a cylindrical shape of a cross-sectional size slightly less than a cross-sectional size of the outer cylinder 25. An inner end opening 26a in the longitudinal direction, an inner edge opening 26b in the width direction, and an inner ventilation window 26e are provided in the inner cylinder 26.

One end of the inner cylinder 26 is opened as the warm air inlet 24. For example, the inner end opening 26a may be provided at a rear end of the inner cylinder 26 in the longitudinal direction. The inner end opening 26a forms the warm air inlet 24 together with the outer end opening 25a. One surface of the inner cylinder 26 is opened as the opening 22. For example, the inner edge opening 26b may be provided in one surface of the inner cylinder 26 in the width direction, for example, an upper surface. The inner edge opening 26b forms the opening 22 together with the outer edge opening 25b. A front end of the inner cylinder 26 is blocked by a front wall 26c. A plurality of inner ventilation windows 26e are provided in a grid shape so as to overlap the outer ventilation window 25d on a surface of the inner cylinder 26 in the width direction, for example, a part from the upper surface to a left side surface. The plurality of inner ventilation windows 26e form the warm air outlet 27 together with the plurality of outer ventilation windows 25d. The main filter 50 is provided in a plurality of inner ventilation windows 26e and covers the plurality of inner ventilation windows 26e. The main filter 50 may be attached to an inner surface of the inner cylinder 26. For example, the main filter 50 may include a sheet shape resin mesh.

The entire length of the inner cylinder 26 may be substantially the same as the length of the outer cylinder 25. A connection frame 26d connected to the blowing path 4 is provided at a rear end of the inner cylinder 26. The connection frame 26d may have, for example, a rectangular shape. The total length of the inner cylinder 26 may be determined so that the connection frame 26d contacts an outer portion of the outer end opening 25a of the outer cylinder 25 when the inner cylinder 26 is inserted into the outer cylinder 25 to a inserted position (appropriate position) where the front wall 26c touches the front end of the outer cylinder 25.

When the amount of lint captured in the main filter 50 and the auxiliary filter 60 (especially in the main filter 50) increases, the mesh is clogged, makes it difficult for the warm air to flow. Therefore, filter cleaning of cleaning the main filter 50 and the auxiliary filter 60 regularly and removing lint attached to the main filter 50 and the auxiliary filter 60 is necessary. Filter cleaning may be a burden on the user. In the case of a filter with a two-stage structure, the burden of cleaning work is even greater. Filter cleaning work may be automated, but the structure of a cleaning mechanism may be complicated and the cost may increase.

According to the disclosure, the filter cleaning mechanism 70 is provided in the unit body 20 to enable easy and convenient filter cleaning work by easily scraping off lint attached to the main filter 50 and the auxiliary filter 60 manually. The filter cleaning mechanism 70 may include a first cleaning mechanism including a first cleaning member 71 scraping off lint attached to the main filter 50. The filter cleaning mechanism 70 may further include a second cleaning mechanism including a second cleaning member 73 scraping off lint attached to the auxiliary filter 60. The filter cleaning mechanism 70 is movable relative to a lint filter, for example, the main filter 50 and the auxiliary filter 60. The movement of the filter cleaning mechanism 70 is allowed or blocked by opening and closing the lid 30. For example, when the lid 30 is at the opening position, the relative movement of the filter cleaning mechanism 70 is allowed, and when the lid 30 is at the closing position, the relative movement of the filter cleaning mechanism 70 is blocked.

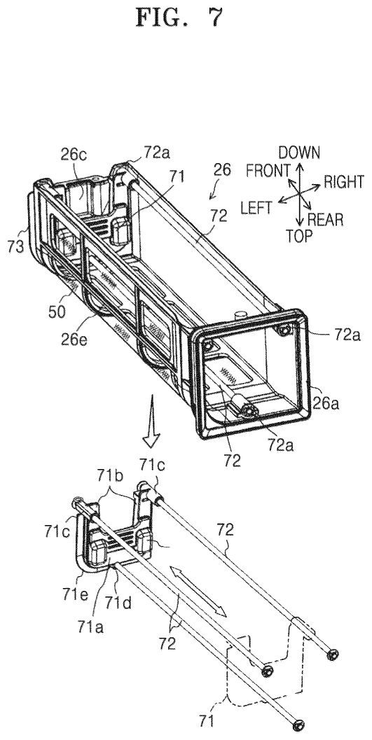

FIG. 7 is a schematic perspective view of a first cleaning mechanism according to one or more embodiments of the disclosure. Referring to FIG. 7, the first cleaning mechanism may be installed in the inner cylinder 26. The first cleaning mechanism may include the first cleaning member 71 cleaning the main filter 50. The first cleaning member 71 includes a first scraper 71e in contact with the main filter 50, and may be installed in the inner cylinder 26 to be movable in a longitudinal direction of the intermediate path 21 to scrape lint attached to the main filter 50.

For example, three guide bars 72 may extend from a front end to a rear end of the inner cylinder 26. Two guide bars 72 may be respectively located on lower left and right edges of the inner cylinder 26. One guide bar 72 may be located in the central portion in left and right directions of an upper portion of the inner cylinder 26. Both ends of each of the three guide bars 72 may be fixed to boss portions 72a provided in the inner cylinder 26.

The first cleaning member 71 may be a resin molded product having a substantially U shape when viewed in front and rear directions. The first cleaning member 71 may include a handle portion 71a and a pair of support arm portions 71b extending downward from a lower end of the handle portion 71a and facing each other in the left and right directions. A lower guide portion 71c is formed on each of the pair of support arm portions 71b. An upper guide portion 71d is formed on an upper edge of the handle portion 71a.

The guide bar 72 is inserted so as to be slidable in each of the two lower guide portions 71c and the upper guide portion 71d. The first cleaning member 71 is supported by the guide bars 72 to be slidable in a longitudinal direction, that is, in the front and rear directions, along the inside of the inner cylinder 26, that is, the intermediate path 21. The first cleaning member 71 may slide to a position (a standby position) close to the front wall 26c of the inner cylinder 26 and a position (a disposal position) close to the inner end opening 26a.

The first cleaning member 71 includes a first scraper 71e scraping off lint of the main filter 50. The first scraper 71e may include an elastic member such as rubber. The first scraper 71e may have an approximately L shape. The first scraper 71e may be installed on the first cleaning member 71 to extend along a part of the first cleaning member 71 reaching a left edge and a lower edge. When the first cleaning member 71 is assembled to the inner cylinder 26, an end of the first scraper 71e elastically contacts the inner surface of the inner cylinder 26 on which the main filter 50 is installed.

According to the disclosure, when the lid 30 is located at the closing position, the first cleaning member 71 is locked in the standby position by the lid 30. Referring to FIGS. 4 and 5, a regulation rib 32 is provided on the lid 30. When the inner cylinder 26 is inserted into the outer cylinder 25 to the appropriate position, the regulation rib 32 locks the first cleaning member 71 to the standby position to prevent movement from the standby position. The regulation rib 32 may be provided on an inner surface of the lid 30.

The regulation rib 32 may protrude upward from the inner surface of the lid 30. The regulation rib 32 may extend in the longitudinal direction of the intermediate path 21, that is, in the front and rear directions, around a left edge of the lid 30. While the lid 30 is closed, a protrusion end 32b of the regulation rib 32 is located above a lower end of the first cleaning member 71, for example, the left support arm portion 71b. That is, while the lid 30 is closed, the protrusion end 32b of the regulation rib 32 and the left support arm 71b of the first cleaning member 71 partially overlap each other in up and down directions.

As a result, a concave portion 33 into which the left support arm portion 71b of the first cleaning member 71 is inserted is formed in a front end portion 32a of the regulation rib 32. When the inner cylinder 26 is inserted into the outer cylinder 25 to the appropriate position and the first cleaning member 71 is located at the standby position, the lower end of the left support arm portion 71b is inserted into the concave portion 33, and the front end 32a of the regulation rib 32 is located close to a backside of the lower end of the left support arm portion 71b. Therefore, when the lid 30 is closed, the first cleaning member 71 may not slide from the standby position to the disposal position. The lower end of the left support arm portion 71b is released from the concave portion 33 by opening the lid 30, and thus, the first cleaning member 71 may be slidable from the standby position to the disposal position. As a result, the first cleaning member 71 may be prevented from being inadvertently separated from the standby position.

In addition, when the first cleaning member 71 is out of the standby position, the first cleaning member 71 interferes with the lid 30 so that the lid 30 is not switched to the closing position. The case where the first cleaning member 71 is out of the standby position may include the case where the inner cylinder 26 is not inserted into the outer cylinder 25 to the appropriate position, and the case where, even when the inner cylinder 26 is inserted into the outer cylinder 25 to the appropriate position, the first cleaning member 71 is not located at the standby position within the inner cylinder 26. In this case, when closing the lid 30, the left support arm portion 71b of the first cleaning member 71 and the regulation rib 32 are in contact with each other, and thus, the lid 30 is not closed. As described above, when the lid 30 is closed, the protrusion end 32b of the regulation rib 32 is located above the lower end of the left support arm portion 71b of the first cleaning member 71. Therefore, when the inner cylinder 26 is not inserted into the outer cylinder 25 to the appropriate position, and when the first cleaning member 71 is not located at the standby position within the inner cylinder 26, because the lower end of the left support arm portion 71b is not inserted into the concave portion 33, when the lid 30 is closed, the protrusion end 32b of the regulation rib 32 hits the lower end of the left support arm portion 71b and the lid 30 is not completely closed. As a result, the lid 30 may not be completely closed unless the inner cylinder 26 is inserted into the outer cylinder 25 to the appropriate position, and the first cleaning member 71 is located at the standby position. Therefore, proper and reliable handling of the inner cylinder 26 and the first cleaning member 71 may be secured.

Relative movement of the first cleaning member 71 to the main filter 50 is possible when the lid 30 is located at the opening position. The lint filter unit 10 is taken out of the lint filter accommodation chamber 8 and turned over, and then the lid 30 is switched from the closing position to the opening position, and thus, the first cleaning member 71 may be movable from the standby position in the longitudinal direction of the intermediate path 21 to scrape the lint attached to the main filter 50. When the lid 30 is opened, access to the first cleaning member 71 inside the inner cylinder 26 is possible, and the first cleaning member 71 may be manually operated. While the lid 30 is opened, the first cleaning member 71 may manually slide from the standby position to the disposal position by holding the handle portion 71a. The lint attached to the main filter 50 may be separated from the main filter 50 by the first scraper 71e and disposed from the inside of the inner cylinder 26 through the inner end opening 26a. The inner end opening 26a functions as a lint disposal port.

Referring to FIGS. 6 and 7, the second cleaning mechanism may include a second cleaning member 73 installed on the inner cylinder 26 to scrape off lint attached to the auxiliary filter 60 when the inner cylinder 26 is taken out of the outer cylinder 25. The second cleaning member 73 may be a second scraper scraping off the lint of the auxiliary filter 60. Hereinafter, the second cleaning member 73 will be referred to as a second scraper 73. The second scraper 73 may include an elastic material such as rubber. The second scraper 73 may have, for example, an approximately L shape. An outer end of the second scraper 73 may elastically contact the auxiliary filter 60.

The second scraper 73 may extend along an outer edge (a part reaching a left edge and an upper edge) of a front end of the inner cylinder 26. When the inner cylinder 26 is inserted into the outer cylinder 25, the end of the second scraper 73 may contact the inner surface of the outer cylinder 25 in which the auxiliary filter 60 is installed. Therefore, the lint attached to the auxiliary filter 60 may be scraped off by the second scraper 73 by taking the inner cylinder 26 out of the outer cylinder 25 and discarded to the outside of the inner cylinder 26 through the outer end opening 25a. In this regard, the outer end opening 25a is used as a lint disposable port.

Because movement of the first cleaning member 71 installed in the inner cylinder 26 is regulated by the regulation rib 32, the movement of the inner cylinder 26 to the outer cylinder 25 is also blocked by the regulation rib 32 of the lid 30 located at the closing position. Therefore, it is possible to operate the second scraper 73, that is, to take the inner cylinder 26 out of the outer cylinder 25, by taking the lint filter unit 10 out of the lint filter accommodation chamber 8 and opening the lid 30.

The lid 30 may not be opened unless the lint filter unit 10 is taken out of the lint filter accommodation chamber 8. For filter cleaning work, it is necessary to turn over the lint filter unit 10. The user takes the lint filter unit 10 out of the lint filter accommodation chamber 8, and then turns over the lint filter unit 10 so that a lower side of the lint filter unit 10 faces upward and opens the lid 30 in that state. The rear end of the unit body 20 in which the warm air inlet 24 is formed is located above a trash can, and the first cleaning member 71 slides to scrape off the lint attached to the main filter 50. In addition, the lint attached to the auxiliary filter 60 may be scraped off using the second cleaning member 73 by taking the inner cylinder 26 out of the outer cylinder 25. As a result, the lint attached to the main filter 50 and/or the auxiliary filter 60 may be easily scraped off and disposed of.

In order to accommodate the lint filter unit 10 in the lint filter accommodation chamber 8, it is necessary to turn over the lint filter unit 10. As described above, the lid 30 may not be completely closed unless the inner cylinder 26 is inserted into the outer cylinder 25 to the appropriate position, and the first cleaning member 71 is located at the standby position. When the lint filter unit 10 is turned over in this state, because the lid 30 faces downward, the lid 30 is opened wide. Therefore, when the lint filter unit 10 is accommodated in the lint filter accommodation chamber 8, the user may reliably confirm the opening and closing of the lid 30, and mis-operation such as incomplete insertion of the inner cylinder 26 into the outer cylinder 25 or dislocation of the first cleaning member 71 may be reliably prevented.

As described above, in the lint removing device according to one or more embodiments of the disclosure, the first cleaning member 71 is operated by opening the lid 30, and thus, the lint attached to the main filter 50 may be scraped off and disposed of through the inner end opening 26a. In addition, according to an operation of taking the inner cylinder 26 by opening the lid 30, and thus, the lint attached to the auxiliary filter 60 may be scraped off and disposed of through the outer end opening 25a. The filter having a two-stage structure may be conveniently cleaned by a manual operation made possible by opening the lid 30.

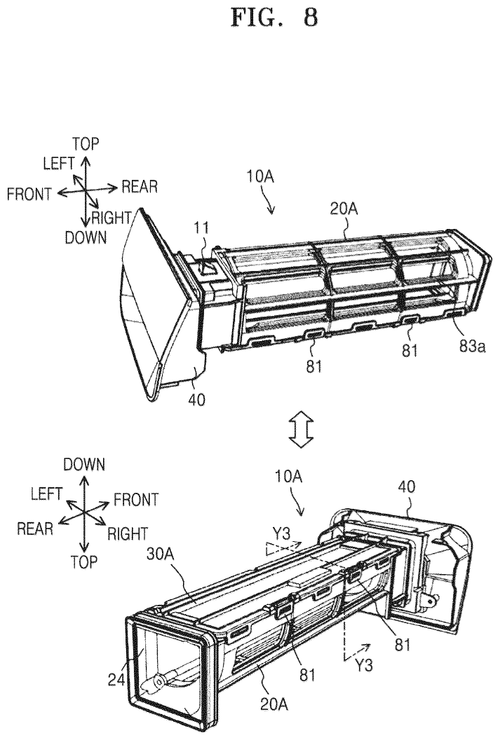

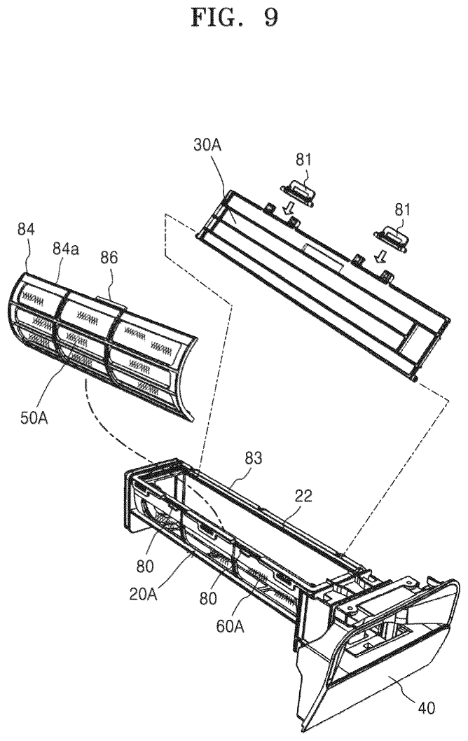

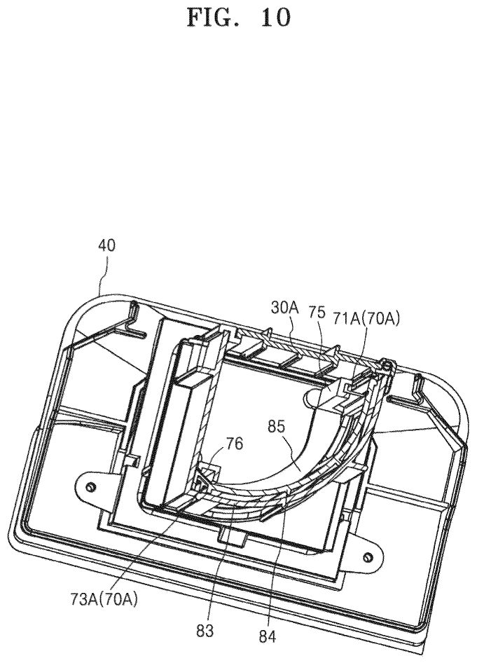

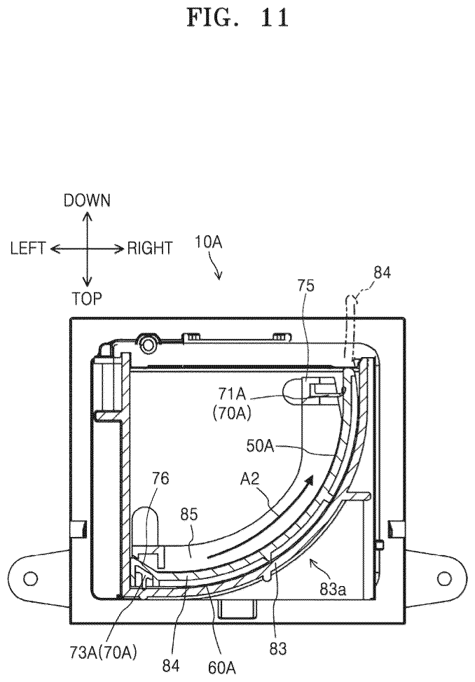

FIG. 8 is a schematic perspective view of a lint filter unit 10A according to one or more embodiments of the disclosure. An upper figure of FIG. 8 shows a state in which the lint filter unit 10A is taken out of the lint filter accommodation chamber 8, and a lower figure of FIG. 8 shows a state in which the lint filter unit 10A is turned over for cleaning. FIG. 9 is a schematic exploded perspective view of the lint filter unit 10A according to one or more embodiments of the disclosure shown in FIG. 8. FIG. 10 is a schematic cross-sectional perspective view taken along line Y3-Y3 of FIG. 8. FIG. 11 is a schematic cross-sectional view taken along line Y3-Y3 of FIG. 8. The lint filter unit 10A of the present embodiment may be applied to the clothing dryer 1 in which the lint filter accommodation chamber 8 is located adjacent to the left of the heat exchanger 5. The basic structure of the lint filter unit 10A is the same as that of the lint filter unit 10 described above. Therefore, among the components of the lint filter unit 10A, the components having the same function as the lint filter unit 10 are indicated by the same reference numerals, and descriptions thereof are omitted or simplified. However, some components having the same functions but different structures are indicated by “A” with reference numerals thereof.

Referring to FIGS. 8 to 11, the lint filter unit 10A may include a unit body 20A, a lid 30A, and the handle 40. A main filter 50A, an auxiliary filter 60A, and a lint cleaning mechanism 70A that scrapes off lint attached to each of the main filter 50A and the auxiliary filter 60A are installed in the unit body 20A.

Referring to FIGS. 8 and 9, the opening 22 is provided in a lower surface of the unit body 20A. The lid 30A opening and closing the opening 22 is assembled to the unit body 20A. The engaging portions 80 are provided at two locations on a right edge of the opening 22. A pair of hooks 81 engaged with the engaging portions 80 are provided on the lid 30A. A user operates the hooks 81, so that the lid 30A may be operated in a closed state and an open state.

The handle 40 is coupled to a front end of the unit body 20A. The warm air inlet 24 is provided in a rear end of the unit body 20A. The main filter 50A and the auxiliary filter 60A are installed on an outer circumferential surface of the unit body 20A reaching a right side surface and an upper surface.

Referring to FIG. 9, the unit body 20A includes a base 83 and a cover 84. The base 83 and the cover 84 respectively correspond to the outer cylinder 25 and the inner cylinder 26 in the above-described embodiment.

Referring to FIGS. 8 to 11, the base 83 is a component corresponding to the outer cylinder 25 of the above-described embodiment. The base 83 may have a cylindrical shape in a fan-shaped cross-sectional area. A rear end of the base 83 is opened to function as the warm air inlet 24. An outer circumferential curved surface 83a having an arc-shaped cross-section is provided on a part of the base 83 reaching from an upper surface to a right surface. The lower surface and the left side surface of the base 83 may be substantially flat surfaces. The opening 22 is provided in one surface, for example, a lower surface, facing the outer circumferential curved surface 83a of the base 83. The lid 30A opens and closes the opening 22. The auxiliary filter 60A is installed on the outer circumferential curved surface 83a of the base 83. At both front and rear ends of the base 83, a pair of slide guides 85 are provided to face each other in front and rear directions. Each of the pair of slide guides 85 may have an arc shape extending along the outer circumferential curved surface 83a when viewed from the front and rear directions.

The cover 84 is a component detachably mounted inside the base 83 through the opening 22. The cover 84 may be a sheet shape member having an arc-shaped cross-section having substantially the same shape and size as the outer circumferential surface 83a so as to overlap the inside of the auxiliary filter 60A. The main filter 50A is installed on the cover 84 to face the auxiliary filter 60A. The cover 84 is mounted on the base 83 while both ends in the front and rear directions are supported by the pair of slide guides 85. A convex portion 86 is provided on an edge portion 84a of the cover 84 adjacent to the opening 22. The convex portion 86 may be provided near the central portion of the edge portion 84a in the front and rear directions. The cover 84 may be taken through the opening 22 by holding the convex portion 86. The cover 84 may slide along the outer circumferential curved surface 83a and removed from the base 83.

Referring to FIGS. 10 and 11, the lint cleaning mechanism 70A may include a first cleaning member 71A scraping off the lint of the main filter 50A. The first cleaning member 71A is supported by the base 82 so as to be in contact with the main filter 50A. The filter cleaning mechanism 70A may further include a second cleaning member 73A scraping off the lint of the auxiliary filter 60A. The second cleaning member 73A is supported by the cover 84 to be in contact with the auxiliary filter 60A.

The first cleaning member 71A may include a first scraper including an elastic material. Hereinafter, the first cleaning member 71A is described as a first scraper 71A. The first scraper 71A is supported by a support member 75 installed between edges close to the opening 22 of the pair of slide guides 85, and extends in the longitudinal direction of the intermediate path 21 from a front end to a rear end of the base 83. An end portion of the first scraper 71A elastically contacts an inner surface of the main filter 50A.

The second cleaning member 73A includes a second scraper including an elastic material. Hereinafter, the second cleaning member 73A is described as a second scraper 73A. The second scraper 73A is located near an edge far from the opening 22 of the cover 84 and extends in an axial direction, that is, in the front and rear directions, from a front end to a rear end of the cover 84. For example, the support portion 76 may be provided near the edge far from the opening 22 of the cover 84, and the second scraper 73A may be supported by the support portion 76. An end portion of the second scraper 73A elastically contacts an inner surface of the auxiliary filter 60A.

The cover 84 may be taken out of the base 83 in a direction of arrow A2 after the lid 30A is located at the opening position. In this process, the lint attached to the main filter 50A and the auxiliary filter 60A is simultaneously scraped. Specifically, because the cover 84 slides in the direction of arrow A2 while the first scraper 71A elastically contacts the inner surface of the main filter 50A, the first scraper 71A is moved relative to the main filter 50A. In this process, the lint attached to the entire surface from a lower edge to an upper edge of the main filter 50A may be scraped off from the main filter 50A. In addition, because the cover 84 slides in the direction of arrow A2 while the second scraper 73A elastically contacts the inner surface of the auxiliary filter 60A, the second scraper 73A is moved relative to the auxiliary filter 60A. In this process, the lint attached to the entire surface from an upper edge to a lower edge of the filter 60A may be scraped off from the auxiliary filter 60A.

The lint of the main filter 50A and the auxiliary filter 60A may be scraped off by an operation of opening the lid 30A and taking the cover 84 out of the base 83. Therefore, the lint removing device of the present embodiment may enable to easily and conveniently clean a filter having a two-stage structure.

One or more embodiments of the lint removing device according to the disclosure is not limited to the above-described embodiments, and may include other components not mentioned.

The lint removing device according to the disclosure is not limited to a clothing dryer, but may also be applied to various devices that dry clothing by circulating and supplying warm air, for example, a washing dryer. A location of a lint filter accommodation chamber with respect to a heat exchanger may be either the left or the right. A location of a lint filter may be changed according to the relative location of the lint filter accommodation chamber with respect to the heat exchanger.

The disclosure provides the lint removing device disposed in a blowing path that circulates and supplies warm air to dry clothing, and the clothing dryer employing the lint removing device. The disclosure provides the lint removing device that may easily clean a main filter and an auxiliary filter with a relatively simple structure and the clothing dryer employing the lint removing device. The disclosure provides the lint removing device capable of reducing the burden of lint cleaning work of a user and the clothing dryer employing the lint removing device.

According to an aspect of the disclosure, a clothing dryer includes a blowing path through which warm air to be supplied to clothing to be dried circulates, a heat exchanger installed in the blowing path to supply heat to the warm air, and a lint filter unit located at an upstream side of the heat exchanger in the blowing path to filter off lint from the warm air. The lint filter unit includes a unit body including an intermediate path connected to the blowing path and an opening for opening a part of the intermediate path, and located at the upstream side of the heat exchanger in the blowing path, a lint filter disposed in the intermediate path to filter off the lint included in the warm air, a filter cleaning mechanism being movable relative to the lint filter to scrape off lint attached to the lint filter, and a lid configured to open and close the opening, block movement of the filter cleaning mechanism when located at a closing position for closing the opening, and allow the movement of the filter cleaning mechanism when located at an opening position for opening the opening. According to this configuration, it is possible to prevent lint from entering the heat exchanger by filtering off the lint included in the warm air by using the lint filter unit installed at the upstream side of the heat exchanger, and removing the lint captured in the lint filter unit by using the filter cleaning mechanism. In addition, because the movement of the filter cleaning mechanism is possible by switching the lid to the opening position, it is possible to clean the lint filter unit by manually operating the filter cleaning mechanism after removing the lint filter unit from the clothing dryer.

According to one or more embodiments of the disclosure, the unit body may include a warm air inlet through which the warm air flows from the intermediate path, and a warm air outlet through which the warm air is discharged from the intermediate path, and the lint filter may be provided in the warm air outlet. Accordingly, lint may be filtered from the warm air before the warm air flows into the heat exchanger.

According to one or more embodiments of the disclosure, a cross-sectional area of the warm air outlet may be larger than a cross-sectional area of the warm air inlet. According to this configuration, a sufficient amount of warm air may flow into the heat exchanger even when there is flow resistance in the blowing path including the intermediate path by the lint filter and lint captured in the lint filter.

According to one or more embodiments of the disclosure, the lint filter may include a main filter and an auxiliary filter located at downstream side of the main filter. The filter cleaning mechanism may include first cleaning member configured to clean the main filter and second cleaning member configured to clean the auxiliary filter. The lint included in the warm air may be effectively removed, by employing the lint filter of a two-stage structure including the main filter and the auxiliary filter. In addition, the main filter and the auxiliary filter may be cleaned by placing the lid at the opening position and manually moving the filter cleaning mechanism, and thus, the structure of the cleaning mechanism is relatively simple.

According to one or more embodiments of the disclosure, when the lid is located at the closing position, the first cleaning member may be locked in a standby position by the lid. According to one or more embodiments of the disclosure, when the first cleaning member is out of the standby position, the first cleaning member may interfere with the lid so that the lid is not switched to the closing position. According to one or more embodiments of the disclosure, when the lid is located at the opening position, the first cleaning member is movable from the standby position in a longitudinal direction of the intermediate path to scrape off the lint attached to the main filter, and the second cleaning member is movable in the longitudinal direction of the intermediate path together with the main filter to scrape off the lint attached to the auxiliary filter. According to this configuration, the movement of the first cleaning member and the second cleaning member is possible when the lid is located at the opening position, and switching of the lid to the opening position is possible when the first cleaning member is located at the standby position. Thus, inadvertent movement of the first cleaning member and the second cleaning member may be prevented. In addition, when the first cleaning member and the second cleaning member are not located at a certain position (standby position), the lid may not be switched to the closing position, and thus, it may be easily confirmed whether the first cleaning member and the second cleaning member are out of the certain position (standby position) before installing the lint filter unit in the clothing dryer.

According to one or more embodiments of the disclosure, when the lid is located at the opening position, the second cleaning member may be movable along an arc-shaped path in a width direction of the intermediate path together with the main filter, and the first cleaning member may scrape off the lint from the main filter that is relatively moved at a fixed position. According to such a configuration, it is possible to implement the filter cleaning mechanism having a simple structure that is movable along a path on the arc in the width direction.

According to one or more embodiments of the disclosure, the unit body may include a cylindrical outer cylinder including an outer end opening in a longitudinal direction, an outer edge opening in a width direction, and an outer ventilation window, and an outer cylinder having a cylindrical shape with the intermediate path inside, including an inner end opening in the longitudinal direction, an inner edge opening in the width direction, and an inner ventilation window, and being insertable into the outer cylinder through the outer end opening, The outer end opening and the inner end opening may form the warm air inlet in the intermediate path. The outer edge opening and the inner edge opening may form the opening. The outer ventilation window and the inner ventilation window may form the warm air outlet facing the heat exchanger and through which warm air is discharged from the intermediate path. The lint filter may include a main filter provided in the inner ventilation window and an auxiliary filter provided in the outer ventilation window. According to this configuration, the main filter and the auxiliary filter may be disposed at the upstream side of the heat exchanger with a simple structure, while each occupying a large area. Therefore, even when there is a flow resistance by these filters, warm air may smoothly flow into the heat exchanger.

According to one or more embodiments of the disclosure, the filter cleaning mechanism may include a first cleaning member including a first scraper in contact with the main filter and installed on the inner cylinder to be movable in the longitudinal direction of the intermediate path, and a second cleaning member installed on the inner cylinder to scrape off lint attached to the auxiliary filter when taking the inner cylinder out of the outer cylinder. According to this configuration, lint attached to the main filter may be scraped off by manually moving the first cleaning member. In addition, lint attached to the auxiliary filter may be scraped off by taking the inner cylinder out of the outer cylinder. Therefore, the lint attached to the main filter and the auxiliary filter may be removed with the simple structure.

According to one or more embodiments of the disclosure, the lid may include a regulation rib. When the inner cylinder is inserted into the outer cylinder to an appropriate position while the first cleaning member is located at the standby position, and when the lid is located at the closing position, the regulation rib may lock the first cleaning member in the standby position. According to one or more embodiments of the disclosure, when the lid is located at the closing position, a movement of the inner cylinder to the outer cylinder may be blocked by the regulation rib. According to this configuration, when the lid is disposed at the closing position, the first cleaning member is locked in the standby position, and thus, the first cleaning member may not be inadvertently out of the standby position or the inner cylinder may not be inadvertently out of an appropriate position while the inner cylinder is inserted into the outer cylinder.

According to one or more embodiments of the disclosure, when the first cleaning member is located at a position other than the standby position, and the inner cylinder is not inserted into the outer cylinder to the appropriate position, the regulation rib may contact the first cleaning member when the lid is switched to the closing position so that the lid is not located at the closing position. According to this configuration, the lid may be completely switched to the closing position only when the inner cylinder is inserted into the outer cylinder to the appropriate position and the first cleaning member is located at the standby position. Therefore, proper and reliable handling of the inner cylinder and the first cleaning member may be secured.

According to one or more embodiments of the disclosure, the lint filter may include a main filter and an auxiliary filter located at a downstream side of the main filter. The unit body may include a base having a cylindrical shape in a fan-shaped cross-sectional shape, in which the auxiliary filter is installed on an arc-shaped outer circumferential surface, and the opening is provided in one surface facing the arc-shaped outer circumferential surface, and a cover being a member having an arc-shaped cross-section detachably disposed inside the base through the opening, in which the main filter is installed to face the auxiliary filter. The filter cleaning mechanism may include a first cleaning member supported by the base to be in contact with the main filter, and a second cleaning member supported by the cover to be in contact with the auxiliary filter. The filter cleaning mechanism may simultaneously scraped off lint attached to the main filter and the auxiliary filter by using the first cleaning member and the second cleaning member by taking the cover out of the base while the lid is located at the opening position. According to this configuration, the lint attached to the main filter and the auxiliary filter may be simultaneously scraped off by taking the cover out of the base, and thus, efficient and convenient lint cleaning is possible.

According to one or more embodiments of the disclosure, the opening of the unit body may be provided in a lower surface of the unit bodies. According to this configuration, when the lid is not completely switched to the closing position, the lid may be opened when the lint filter unit is mounted on the clothing dryer. Therefore, whether the lid is opened or closed may be easily confirmed, and thus, inadvertent mis-operation of the lint filter unit including the filter cleaning mechanism may be prevented.

According to an aspect of the disclosure, a lint removing device disposed in a blowing path that circulates warm air to dry clothing may include a heat exchanger installed in the blowing path, a lint filter accommodation chamber installed at an upstream side of the heat exchanger, and a lint filter unit detachably accommodated in the lint filter accommodation chamber. The lint filter unit may include a unit body having an intermediate path forming the blowing path inside, and a lid assembled to the unit body to open and close an opening facing the intermediate path. The unit body may include a main filter facing the intermediate path, an auxiliary filter disposed at a downstream side of the main filter, and a filter cleaning mechanism scraping off lint attached to each of the main filer and the auxiliary filter. The operation of the filter cleaning mechanism is possible by opening the lid.

According to one or more embodiments of the disclosure, the unit body may include an outer cylinder having a cylindrical shape in which one end is opened as a warm air inlet and simultaneously one surface is opened as the opening, and the auxiliary filter and the lid are installed, and an inner cylinder having a cylindrical shape in which one end is opened as the warm air inlet and simultaneously one surface is opened as the opening, a cross-section is similar to that of the outer cylinder, and the main filter is installed to overlap the auxiliary filter. The unit body may be disposed adjacent to the heat exchanger while the auxiliary filter and the main filter face the heat exchanger by inserting the inner cylinder into the outer cylinder.

According to one or more embodiments of the disclosure, the filter cleaning mechanism may include a first cleaning member installed on the inner cylinder to be slidable in the longitudinal direction of the intermediate path while contacting the main filter. The lint attached to the main filter may be scraped off, by opening the lid and manually sliding the first cleaning member.

According to one or more embodiments of the disclosure, a regulation rib preventing the first cleaning member from moving from a standby position when the inner cylinder is inserted into the outer cylinder to an appropriate position may be provided on the lid.

According to one or more embodiments of the disclosure, the inner cylinder may be detachable from the outer cylinder, and the filter cleaning mechanism may include a second cleaning member installed on the inner cylinder to be in contact with the auxiliary filter. The first cleaning member may scrape off the lint attached to the auxiliary filter by opening the lid and taking the inner cylinder out of the outer cylinder.

According to one or more embodiments of the disclosure, the regulation rib may extend in the longitudinal direction of the intermediate path. When the inner cylinder is not inserted of the outer cylinder to an appropriate position, the first cleaning member and the regulation rib may be in contact with each other so that the lid may not be closed.

According to one or more embodiments of the disclosure, the lint filter unit may further include a handle coupled to the unit body to enable insertion/withdrawal operations of the lint filter unit into/from the lint filter accommodation chamber. The warm air inlet may be located at an opposite side of the handle, and the opening may be located at the bottom of the lint filter unit.

According to one or more embodiments of the disclosure, the unit body may include a base having a cylindrical shape in a fan-shaped cross-sectional shape in which one end is opened as a warm air inlet and simultaneously one surface is opened as the opening, the lint filter unit filter being installed on an arc-shaped outer circumferential surface of the base, and the lid being installed on the one surface of one side leading to the outer circumferential surface, a cover having a sheet shape having an arc-shaped cross-section in which the main filter is installed to overlap the auxiliary filter, and mounted inside the base, and a pair of slide guides installed on the base to support the cover so as to be slidable along the outer circumferential surface. The filter cleaning mechanism may include a first cleaning member supported by edges of the pair of slide guides adjacent to the opening to extend in the longitudinal direction and contacting an inner surface of the main filter, and a second cleaning member installed on the opposite edge of the opening of the cover to extend in the longitudinal direction and contacting an inner surface of the auxiliary filter. The first cleaning member and the second cleaning member may respectively scrape off the lint attached to the main filter and the auxiliary filter by opening the lid and taking the cover out of the base.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A clothing dryer comprising:
a blowing path through which warm air circulates;
a heat exchanger in the blowing path and configured to supply heat to the warm air; and
a lint filter unit at an upstream side of the heat exchanger in the blowing path and configured to filter lint from the warm air,
wherein the lint filter unit comprises:
a unit body comprising:
an intermediate path connected to the blowing path; and
an opening, located at the upstream side of the heat exchanger in the blowing path, for a part of the intermediate path;
a lint filter in the intermediate path and configured to filter the lint included in the warm air;
a filter cleaner movable relative to the lint filter and configured to scrape off the lint attached to the lint filter; and
a lid configured to open and close the opening, block movement of the filter cleaner in a state in which the lid is at a closing position, and allow movement of the filter cleaner in a state in which the lid is at an opening position.

2. The clothing dryer of claim 1, wherein the unit body further comprises a warm air inlet through which the warm air flows from the intermediate path, and a warm air outlet through which the warm air is discharged from the intermediate path, and
wherein the lint filter is at the warm air outlet.

3. The clothing dryer of claim 2, wherein a cross-sectional area of the warm air outlet is greater than a cross-sectional area of the warm air inlet.

4. The clothing dryer of claim 1, wherein the lint filter comprises:
a main filter; and
an auxiliary filter at downstream side of the main filter, and
wherein the filter cleaner comprises:
a first cleaning member configured to clean the main filter; and
a second cleaning member configured to clean the auxiliary filter.

5. The clothing dryer of claim 4, wherein in a state in which the lid is at the closing position, the first cleaning member is locked in a standby position by the lid.

6. The clothing dryer of claim 5, wherein in a state in which the first cleaning member is no longer in the standby position, the first cleaning member interferes with the lid, and
wherein in a state in which the first cleaning member interferes with the lid, the lid cannot be switched to the closing position.

7. The clothing dryer of claim 5, wherein in a state in which the lid is at the opening position, the first cleaning member is movable from the standby position in a longitudinal direction of the intermediate path and configured to scrape off the lint attached to the main filter, and the second cleaning member is movable in the longitudinal direction of the intermediate path together with the main filter and configured to scrape off the lint attached to the auxiliary filter.

8. The clothing dryer of claim 4, wherein in a state in which the lid is at the opening position, the second cleaning member is movable along an arc-shaped path in a width direction of the intermediate path together with the main filter, and the first cleaning member is configured to scrape off the lint from the main filter that is moved relative to a fixed position.

9. The clothing dryer of claim 2, wherein the unit body further comprises:
an outer cylinder comprising an outer end opening in a longitudinal direction, an outer edge opening in a width direction, and an outer ventilation window; and
an inner cylinder comprising an inner end opening in the longitudinal direction, an inner edge opening in the width direction, and an inner ventilation window, the inner cylinder being insertable into the outer cylinder through the outer end opening and the intermediate path being inside the inner cylinder,
wherein the outer end opening and the inner end opening form the warm air inlet in the intermediate path,
wherein the outer edge opening and the inner edge opening form the opening,
wherein the outer ventilation window and the inner ventilation window form the warm air outlet facing the heat exchanger and through which the warm air is discharged from the intermediate path, and
wherein the lint filter further comprises a main filter in the inner ventilation window and an auxiliary filter in the outer ventilation window.

10. The clothing dryer of claim 9, wherein the filter cleaner further comprises:
a first cleaning member comprising a first scraper on the inner cylinder and contacting the main filter, and movable in the longitudinal direction of the intermediate path; and
a second cleaning member on the inner cylinder and configured to scrape off the lint attached to the auxiliary filter in a state in which the inner cylinder is removed from the outer cylinder.

11. The clothing dryer of claim 10, wherein the lid further comprises a regulation rib, and
wherein in a state in which the inner cylinder is inserted into the outer cylinder to an inserted position, the first cleaning member is at a standby position, and the lid is at the closing position, the regulation rib is configured to lock the first cleaning member in the standby position.

12. The clothing dryer of claim 11, wherein in a state in which the lid is at the closing position, the inner cylinder is blocked from moving to the outer cylinder by the regulation rib.

13. The clothing dryer of claim 11, wherein in a state in which the first cleaning member is at a position other than the standby position, and the inner cylinder is not inserted into the outer cylinder to the inserted position, the regulation rib is configured to contact the first cleaning member when the lid is switched to the closing position, and
wherein the lid is prevented from being at the closing position by the regulation rib.

14. The clothing dryer of claim 1, wherein the lint filter further comprises:
a main filter; and
an auxiliary filter at a downstream side of the main filter,
wherein the unit body further comprises:
a base having a cylindrical shape in a fan-shaped cross-sectional area, the auxiliary filter being on an arc-shaped outer circumferential surface, and the opening is in one surface facing the arc-shaped outer circumferential surface; and
a cover having an arc-shaped cross-section detachably inside the base through the opening, the main filter facing the auxiliary filter,
wherein the filter cleaner further comprises:
a first cleaning member supported by the base and contacting the main filter; and
a second cleaning member supported by the cover and contacting the auxiliary filter, and
wherein the filter cleaner is configured to simultaneously scrape off the lint attached to the main filter and the auxiliary filter, via the first cleaning member and the second cleaning member, by taking the cover out of the base in a state in which the lid is at the opening position.

15. The clothing dryer of claim 1, wherein the opening of the unit body is in a lower surface of the unit body.
